(19) United States
(12) Patent Application Publication
(10) Pub. No.: US 2014/0163969 A1
(43) Pub. Date: Jun. 12, 2014

(54) METHOD AND SYSTEM FOR DIFFERENTIATING TEXTUAL INFORMATION EMBEDDED IN STREAMING NEWS VIDEO

(71) Applicant: Tanushyam Chattopadhyay, Kolkata (IN)

(72) Inventor: Tanushyam Chattopadhyay, Kolkata (IN)

(73) Assignee: Tata Consultancy Services Limited, Mumbai (IN)

(21) Appl. No.: 14/233,727

(22) PCT Filed: Jul. 18, 2012
(86) PCT No.: PCT/IN2012/000504

§ 371 Date: Jan. 17, 2014

(30) Foreign Application Priority Data
Jul. 20, 2011 (IN) 2067/MUM/2011

(51) Int. Cl. G06F 17/21

(52) U.S. Cl. CPC G06F 17/21
USPC 704/9

(57) ABSTRACT

The application provides a method and system for differentiating textual information embedded in a streaming news video. The application enables a method and system for differentiating textual information embedded in a streaming news video for simplified indexing and annotation of the said news video.

### FIELD OF THE APPLICATION

The present application relates to broadcasting and telecommunications. Particularly, the application relates to a statistical approach for differentiating textual information embedded in a streaming news video. More particularly the application enables a method and system for differentiating textual information embedded in a streaming news video for simplified indexing and annotation of the said news video.

### BACKGROUND OF THE APPLICATION

In the broadcasting and telecommunication technology domain, one major challenge of the day is to extract the context from the video. One method of extracting the context is to recognize the text embedded on the video. Video optical character recognition is a method to recognize the text from the video.

In the current scenario, lots of efforts have been made to develop various approaches to solve the said problem, of context recognition. It has a huge application in the problem of automatic video indexing, too. For automatic video indexing or annotation, one required step is to classify the texts embedded within the video. This problem is bigger in case of news video. Existing video text classification methods have addressed the problem using natural language processing (NLP) based approach to differentiate the different segments of a news video.

Extracting the contextual information is still a challenging task because of the variety of content embedded in a video including video, image text etc. A typical streaming news video may contain a combination of textual region, video of the news reader or the regions showing videos and images of the event the anchor is speaking about. The textual regions may be further classified in various groups, such as breaking news, ticker news or the details about the breaking news, channel name, date and time of the program, stock updates/ticker etc.

In order to achieve an accurate differentiation of textual information embedded in streaming news video, a light weight method and system is required which could simplify the indexing and facilitate the annotation of the said news video with light resource (memory and CPU) requirement.

However, the existing methods and systems are not capable of providing a light weight approach for differentiating the textual information embedded in a streaming news video. The existing methods and systems particularly are not capable of providing a light weight approach for classifying the texts of streaming news video without any language model or natural language processing (NLP) based approach.

The existing methods and systems particularly are not capable of differentiating textual information embedded in a streaming news video which could simplify the indexing and facilitate the annotation of the said news video. Some of above mentioned methods known to us are as follows:

U.S. Pat. No. 5,950,196A to Pyreddy et al. teaches about extracting the information from printed news papers/online version of the news paper. The patent does not teach about a statistical approach for extracting and differentiating textual information embedded in a streaming news video.

US2009100454A by Weber et al. teaches about the summarization of text, audio, and audiovisual presentations, such as movies, into less lengthy forms, based on natural language processing (NLP) approach. Weber et al. describes a method for news video summarization. The patent does not teach about a statistical approach for extracting and differentiating textual information embedded in a streaming news video.

US2008077708A by Scott et al. teaches about techniques that enable automated processing of news content according to the user preference. The patent does not teach about a statistical approach for extracting and differentiating textual information embedded in a streaming news video.

US2002152245A by McCaskey et al. teaches about an apparatus and method for receiving daily data feeds of news article text and news images, particularly web publications of news paper content. The patent does not teach about a statistical approach for extracting and differentiating textual information embedded in a streaming news video.

Luo et al. in “Semantic Entity-Relationship Model for Large-Scale Multimedia News Exploration and Recommendation” teaches about a novel framework for multimedia news exploration and analysis, particularly web publishing of news. Luo et al. does not teach about a statistical approach for extracting and differentiating textual information embedded in a streaming news video.

Kankanhalli et al. in “Video modeling using strata-based annotation” aims to achieve efficient browsing and retrieval. Kankanhalli et al. focuses on segmenting the contextual information into chunks rather than dividing physically contiguous frames into shots, as is traditionally done. Kankanhalli et al. does not teach about a statistical approach for extracting and differentiating textual information embedded in a streaming news video.

Bouaziz et al. in “A New Video Images Text Localization Approach Based on a Fast Hough Transform” teaches about a fast Hough transformation based approach for automatic video frames text localization. Bouaziz et al. does not teach about a statistical approach for extracting and differentiating textual information embedded in a streaming news video.

Ziegler et al. in “Content Extraction from News Pages Using Particle Swarm Optimization on Linguistic and Structural Features” teaches about a novel approach that extracts real content from news Web pages in an unsupervised fashion, using particle swarm optimization on linguistic and structural features.

The above mentioned prior arts fail to disclose an efficient method and system for textual information differentiation embedded in a streaming news video. The prior art also fail to disclose about a method and system for differentiating textual information embedded in a streaming news video which could simplify the indexing and facilitate the annotation of the said news video.

Thus, in the light of the above mentioned background art, it is evident that, there is a long felt need for such a solution that can provide an effective method and system for differentiating textual information embedded in a streaming news video. There is also a need for such a solution that enables a cost effective method and system which could simplify the indexing and facilitate the annotation of the said news video.

### OBJECTIVES OF THE APPLICATION

The primary objective of the present application is to provide a method and system for differentiating textual information embedded in a streaming news video.

Another objective of the application is to enable a method and system for differentiating textual information embedded in a streaming news video for simplified indexing and annotation of the said news video.

Another objective of the application is to provide a method and system for computing the frequency of occurrence of characters in upper and lower case, special character and numerical character in the textual information embedded in a streaming news video.

Another objective of the application is to provide a method and system for computing the ratio of the said characters in upper and lower case, special character and numerical character for threshold based differentiation of the textual information embedded in a news video.

### SUMMARY OF THE APPLICATION

Before the present methods, systems, and hardware enablement are described, it is to be understood that this application in not limited to the particular systems, and methodologies described, as there can be multiple possible embodiments of the present application which are not expressly illustrated in the present disclosure. It is also to be understood that the terminology used in the description is for the purpose of describing the particular versions or embodiments only, and is not intended to limit the scope of the present application which will be limited only by the appended claims.

The present application provides a method and system for differentiating textual information embedded in a streaming news video.

In one aspect of the application a method and system is provided for differentiating textual information embedded in a streaming news video for simplified indexing and annotation of the said news video. The frequency of occurrence of characters in upper and lower case, special character and numerical character in the textual information embedded in a streaming news video is computed. Further, the ratio of the said characters in upper and lower case, special character and numerical character for threshold based differentiation of the textual information embedded in a news video is computed. Thus the statistical approach differentiates textual information embedded in a streaming news video. The textual information may include breaking news, ticker news or the details about the breaking news, channel name and date and time of the show.

The above said method and system are preferably a method and system for differentiating textual information embedded in a streaming news video but also can be used for many other applications, which may be obvious to a person skilled in the art.

### BRIEF DESCRIPTION OF DRAWINGS

The foregoing summary, as well as the following detailed description of preferred embodiments, are better understood when read in conjunction with the appended drawings. For the purpose of illustrating the application, there is shown in the drawings exemplary constructions of the application; however, the application is not limited to the specific methods and system disclosed. In the drawings:

FIG. 1 shows prior art flow diagram of the preprocessing of textual information embedded in a streaming news video.

FIG. 2 shows flow diagram of the process for differentiating textual information embedded in a streaming news video.

### DETAILED DESCRIPTION OF THE APPLICATION

Some embodiments of this application, illustrating all its features, will now be discussed in detail.

The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present application, the preferred, systems and methods are now described.

The disclosed embodiments are merely exemplary of the application, which may be embodied in various forms.

The present application provides a method for differentiating textual information embedded in at least one streaming news video, characterized by simplified indexing and annotation of the said streaming news video, the method comprising processor implemented steps of:
a. computing the frequency of occurrence of at least two characters in the textual information embedded in said streaming news video;
b. computing the ratio of the frequency of occurrence of the said characters; and
c. defining a set of rules to the thresholds of the computed ratio of the frequency of occurrence of the said characters for differentiating the textual information embedded in the said streaming news video.

The present application provides a system for differentiating textual information embedded in at least one streaming news video, the system comprising of:
a. at least one computing engine for computing the frequency of occurrence of at least two characters in the textual information embedded in said streaming news video and the ratio of the frequency of occurrence of the said characters; and
b. at least one statistical engine for defining a set of rules to the thresholds of the computed ratio of the frequency of occurrence of the said characters for differentiating the textual information embedded in the said streaming news video.

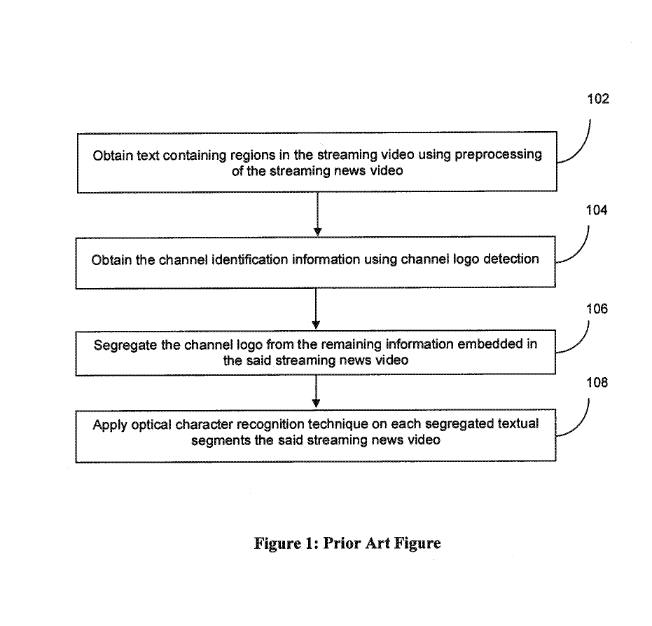

Referring to FIG. 1 is a prior art flow diagram of the preprocessing of textual information embedded in a streaming news video.

The process starts at the step 102, the text containing regions in the streaming video are obtained using preprocessing of the streaming news video. At the step 104, the channel identification information is obtained using channel logo detection. At the step 106, the channel logo is segregated from the remaining information embedded in the said streaming news video. The process ends at the step 108, the optical character recognition technique is applied on each segregated textual segments the said streaming news video.

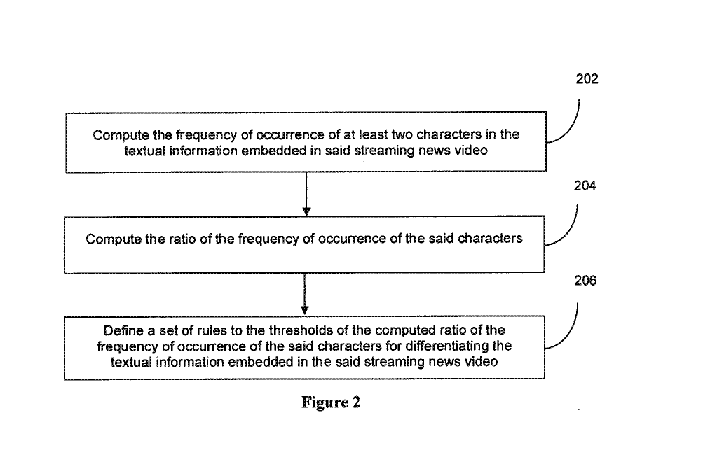

Referring to FIG. 2 is a flow diagram of the process for differentiating textual information embedded in a streaming news video.

The process starts at the step 202, the frequency of occurrence of at least two characters in the textual information embedded in said streaming news video is computed. At the step 204, the ratio of the frequency of occurrence of the said characters is computed. The process ends at the step 206, a set of rules to the thresholds of the computed ratio of the frequency of occurrence of the said characters is defined for differentiating the textual information embedded in the said streaming news video.

In one of the embodiment of the present application, a method and system is provided for differentiating textual information embedded in a streaming news video. The method is characterized by simplified indexing and annotation of the said streaming news video. The identification information of the channel streaming the news video is obtained by channel logo detection techniques available in prior art. The text containing regions are also to be identified. The text containing regions in the streaming video are obtained using preprocessing of the said streaming news video, wherein the detected channel logo is segregated from the remaining information embedded in the said streaming news video. The remaining information embedded in the said streaming news video may contain breaking news, news text, stock update or date and time of the said streaming news video. After obtaining the text containing regions in the streaming video, the channel identification information, segregating the said information from the remaining information, the optical character recognition technique is applied on each segregated textual segments the said streaming news video.

In one of the embodiment of the present application, the frequency of occurrence of optically recognized characters in the textual information is computed. The said characters embedded in said streaming news video are selected from the group comprising of upper case characters, lower case characters, special character or numerical characters. The textual information is selected from the group comprising of breaking news, ticker news or the details about the breaking news, channel name and date and time of the show. Further, the ratio of the frequency of occurrence of the said characters is computed and a set of rules is defined to the thresholds of the computed ratio of the frequency of occurrence of the said characters for differentiating the textual information embedded in the said streaming news video. The set of rules are defined by adding at least one tolerance factor to the said thresholds and the said tolerance factor is obtained from the standard deviation of the observed statistics. The threshold based approach is defined to differentiate the type of texts based on the statistical analysis on the news video corpus in the Table 1.

According to the Table 1, the textual information embedded in the said streaming news video is differentiated as breaking news if the frequency of occurrence of the upper case characters is greater than 90%.

Textual information embedded in the said streaming news video is differentiated as date and time information if the frequency of occurrence of the numerical characters is greater than 50% but the ratio of numerical characters and upper case characters is greater than 3 times.

Textual information embedded in the said streaming news video is differentiated as Stock update if the frequency of occurrence of the upper case and lower case characters are greater than 40% and the ratio of numerical characters and upper case characters is lying near 1 with a range of 0.2 variations.

Textual information embedded in the said streaming news video is differentiated as news details if the frequency of occurrence of the lower case characters is greater than 60%.

TABLE 1
A threshold based approach is defined to differentiate the type of texts
based on the statistical analysis on the news video corpus.

| | | | | | Ratio of |
|---|---|---|---|---|---|
| | % of | % of | | | Numerical |
| | Upper | Lower | % of | % of | characters/ |
| Type of | case | case | Special | Numerical | Upper case |
| Text | characters | characters | characters | characters | characters |
| Breaking | 98 | 0 | 2 | 0 | 0 |
| News | | | | | |
| Date & | 10 | 20 | 10 | 60 | 6 |
| Time | | | | | |
| Stock | 45 | 0 | 10 | 45 | 1 |
| News Text | 8 | 84 | 3 | 5 | 0.6 |

The date, time and channel identification information is further used as a time stamp for indexing of the said streaming news video and furthermore they are being used to fetch additional related more information from internet for indexing of the said streaming news video.

In an embodiment of the application, the system for differentiating textual information embedded in at least one streaming news video comprising of at least one computing engine for computing the frequency of occurrence of at least two characters in the textual information embedded in said streaming news video and the ratio of the frequency of occurrence of the said characters, and at least one statistical engine for defining a set of rules to the thresholds of the computed ratio of the frequency of occurrence of the said characters for differentiating the textual information embedded in the said streaming news video.

The methodology and techniques described with respect to the exemplary embodiments can be performed using a machine or other computing device within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The machine may include a processor (e.g., a central processing unit (CPU), a graphics processing unit (GPU, or both), a main memory and a static memory, which communicate with each other via a bus. The machine may further include a video display unit (e.g., a liquid crystal displays (LCD), a flat panel, a solid state display, or a cathode ray tube (CRT)). The machine may include an input device (e.g., a keyboard) or touch-sensitive screen, a cursor control device (e.g., a mouse), a disk drive unit, a signal generation device (e.g., a speaker or remote control) and a network interface device.

The disk drive unit may include a machine-readable medium on which is stored one or more sets of instructions (e.g., software) embodying any one or more of the methodologies or functions described herein, including those methods illustrated above. The instructions may also reside, completely or at least partially, within the main memory, the static memory, and/or within the processor during execution thereof by the machine. The main memory and the processor also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions, or that which receives and executes instructions from a propagated signal so that a device connected to a network environment can send or receive voice, video or data, and to communicate over the network using the instructions. The instructions may further be transmitted or received over a network via the network interface device.

While the machine-readable medium can be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: tangible media; solid-state memories such as a memory card or other package that houses one or more read-only (non-volatile) memories, random access memories, or other re-writable (volatile) memories; magneto-optical or optical medium such as a disk or tape; non-transitory mediums or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of apparatus and systems that might make use of the structures described herein. Many other arrangements will be apparent to those of skill in the art upon reviewing the above description. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized Accordingly, the specification and drawings are to be regarded in an illustrative rather than a restrictive sense.

The preceding description has been presented with reference to various embodiments. Persons skilled in the art and technology to which this application pertains will appreciate that alterations and changes in the described structures and methods of operation can be practiced without meaningfully departing from the principle, spirit and scope.

Advantages of the Invention:
The method provided by the present invention is robust as the threshold is computed statistically.
The tolerance factor is computed using standard deviation and thus the scope of false classification is also very less.
The method is light weight for classifying the texts of news video without any language model or natural language processing (NLP) based approach.
The approach given in the application is based on the statistical analysis of the corpus.

1. A method for differentiating textual information embedded in a streaming news video, the method comprising:
determining one or more frequencies of occurrences of at least two types of characters in the textual information embedded in the streaming news video;
determining a ratio of the frequency of occurrence of one or more types of the characters with respect to a frequency of occurrence of one or more other types of the characters;
defining a set of rules with respect to thresholds associated with the ratio; and
differentiating the textual information embedded in the streaming news video based on the set of rules and at least one of the ratio and the one or more frequencies of occurrences.

2. The method as claimed in claim 1, wherein the at least two types of characters include at least two of upper case characters, lower case characters, special characters, or numerical characters.

3. The method as claimed in claim 1, wherein the textual information comprises at least one of a breaking news, a ticker news, details about the breaking news, channel identification information, and one or both of a date and a time of a content corresponding to the streaming news video.

4. The method as claimed in claim 1, wherein defining the set of rules comprises adding a tolerance factor to the thresholds to classify the textual information embedded in the streaming news video.

5. (canceled)

6. The method as claimed in claim 2, wherein differentiating the textual information embedded in the at least one streaming news video comprises differentiating the textual information as a breaking news when the frequency of occurrence of the upper case characters is greater than 90% of a total characters present in the textual information.

7. The method as claimed in claim 2, wherein differentiating the textual information embedded in the at least one streaming news video comprises differentiating the textual information as date and time information when the frequency of occurrence of the numerical characters is greater than 50% of a total characters present in the textual information and the ratio of the frequency of occurrence corresponding to the numerical characters with respect to the frequency of occurrence corresponding to the upper case characters is greater than 3.

8. The method as claimed in claim 2, wherein differentiating the textual information embedded in the streaming news video comprises differentiating the textual information as a stock update when the frequency of occurrence of the upper case characters and the lower case characters is greater than 40% of a total characters present in the textual information and the ratio of the frequency of occurrence corresponding to the numerical characters with respect to the frequency of occurrence corresponding to the upper case characters is about 1 with a variation of 0.2.

9. The method as claimed in claim 2, wherein differentiating the textual information embedded in the at least one streaming news video comprises differentiating the textual information as news details when the frequency of occurrence of the lower case characters is greater than 60% of a total characters present in the textual information.

10. The method as claimed in claim 3, further comprising indexing the at least one streaming news video based on at least one of the date, the time and the channel identification information.

11. The method as claimed in claim 10, wherein indexing the streaming news video comprises fetching related information from internet based on the date, the time and the channel identification information.

12. The method as claimed in claim 10, further comprising obtaining the channel identification information based on a channel logo detection.

13. The method as claimed in claim 1, further comprising obtaining text containing regions in the streaming news video based on preprocessing of the streaming news video, wherein the preprocessing segregates a channel log from remaining information embedded in the streaming news video.

14. The method as claimed in claim 13, wherein the remaining information embedded in the streaming news video includes at least one of a breaking news, a news text, a stock update, and a date and a time of the at least one streaming news video.

15. A system for differentiating textual information embedded in at least one streaming news video, the system comprising:
one or more processors; and
a memory storing processor-executable instructions comprising instructions that, when executed by the one or more processors, cause the one or more processors to:
determine one or more frequencies of occurrences of at least two types of characters in the textual information embedded in the streaming news video,
determine a ratio of the frequency of occurrence of the one or more types of characters with respect to the frequency of occurrence of one or more other types of characters,
define a set of rules with respect to thresholds of the ratio, and
differentiate the textual information embedded in the streaming news video based on the set of rules and at least one of the ratio and the one or more frequencies of occurrences.

16. (canceled)

17. A non-transitory computer program product having embodied thereon computer program instructions for differentiating textual information embedded in at least one streaming news video, the computer program product storing instructions that, when executed by one or more processors, cause the one or more processors to operations comprising:
determining one or more frequencies of occurrences of at least two types of characters in the textual information embedded in the at least one streaming news video;
determining a ratio of the frequency of occurrence of one or more types of the characters with respect to the frequency of occurrence of one or more other types of the characters;
defining a set of rules with respect to thresholds of the ratio; and
differentiating the textual information embedded in the streaming news video based on the set of rules and at least one of the ratio and the one or more frequencies of occurrences.
